(19) United States
(12) Patent Application Publication
(10) Pub. No.: US 2009/0114442 A1
(43) Pub. Date: May 7, 2009

(54) Camera Link Booster Cable Assembly

(75) Inventors: John Ray Berst, Plainfield, IL (US); Artur Bernard Didyk, Chicago, IL (US)

Correspondence Address: THOMPSON COBURN LLP, ONE US BANK PLAZA, SUITE 3500, ST LOUIS, MO, 63101, US

(73) Assignee: COMPONENTS EXPRESS, INC., Woodridge, IL (US)

(21) Appl. No.: 11/935,133

(22) Filed: Nov. 5, 2007

(51) Int. Cl. H01R 9/05; H02G 15/02

(52) U.S. Cl. 174/74 R

(57) ABSTRACT

A camera link cable assembly transmits signals from a digital camera to a frame grabber. The cable assembly has a significantly longer length than that provided by camera link cables of the prior art. A signal conditioning device is an integral part of the cable. The signal conditioning device extends the maximum distance that a signal can be transmitted from the camera to a frame grabber from approximately 7 meters at 85 MHz of the prior art cables, to approximately 40 meters at 85 MHz.

### BACKGROUND OF THE INVENTION 1. Field of the Invention

The present invention pertains to a camera link cable assembly that transmits signals from a digital camera to a frame grabber. In particular, the present invention pertains to a camera link booster cable assembly that has a longer length than camera link cables of the prior art, and has a signal conditioning device as an integral part of the cable. The signal conditioning device extends the maximum distance that a signal can be transmitted from a camera to a frame grabber from the approximately 7 meters at 85 MHz of the prior art cables, to approximately 40 meters at 85 MHz.

2. Description of the Related Art

Camera link cables are used in the machine vision industry to connect digital cameras to frame grabbers. Prior art camera link standard cables can transmit a signal from a camera to a separate frame grabber. Currently available cables have a maximum length of approximately 8 meters, and are capable of transmitting an 85 MHz signal using an expensive shielded cable that is approximately 7.5 millimeters in diameter. Thus, the distance that a signal can be transmitted from a camera to a separate frame grabber is limited by the prior art cable. Furthermore, the prior art cable construction limits the speed at which a signal can be transmitted to 85 MHz. Prior art cables are also disadvantaged in that the typical shielded cable having a large diameter of approximately 7.5 millimeters is expensive.

### SUMMARY OF THE INVENTION

The present invention provides a camera link standard booster cable assembly that is powered by a built-in signal conditioning device that allows a signal from a camera to be transmitted to a frame grabber at a significant distance from the camera, the distance being much larger than that enabled by prior art cables.

The cable assembly of the invention is basically comprised of a flexible, elongate length of cable. An electrical conductor extends through the cable, and the conductor is completely surrounded by an electrically insulating shielding.

A first delta ribbon connector is provided at a first end of the cable and is adapted to be removably connected to the electronics of a digital camera. A second delta ribbon connector is provided at the opposite second end of the cable. The second delta ribbon connector is adapted to be removably connected to the electrical system of a frame grabber that is separate from the camera.

The signal conditioning device is provided at the first end of the cable adjacent the first ribbon connector. Both the signal conditioning device and the first ribbon connector are encapsulated in an electrically insulating housing that is also mounted on the cable shielding.

In the preferred embodiment of the invention, the overall length of the cable extending between the first connector and the signal conditioning device and second connector is at least 20 meters, and can be as long as 40 meters. The signal conditioning device is operable to enable the transmission of a signal along the length of the cable assembly from the first connector to the second connector at 85 MHz.

The signal conditioning device of the invention could also be operable to enable the transmission of a signal down the length of the cable assembly from the first connector to the second connector at over 100 MHz. The cable assembly of the invention enables the use of less expensive cable to run high speed video signal transmissions and also enables the use of smaller diameter, less expensive, and more flexible cables, such as LVDS (low voltage differential SCSI cable).

### BRIEF DESCRIPTION OF THE DRAWINGS

Further features of the invention are set forth in the following detailed description of the invention and in the drawing figures.

FIG. 1 is a side view of the camera link booster cable assembly of the invention, with the opposite side of the cable assembly being a mirror image thereof.

FIG. 2 is a perspective view of the cable assembly shown in FIG. 1.

FIG. 3 is a side view of the signal conditioning device of the cable assembly of the invention.

FIG. 4 is a perspective view of the signal conditioning device of FIG. 3.

### DETAILED DESCRIPTION OF THE PREFERRED EMBODIMENT

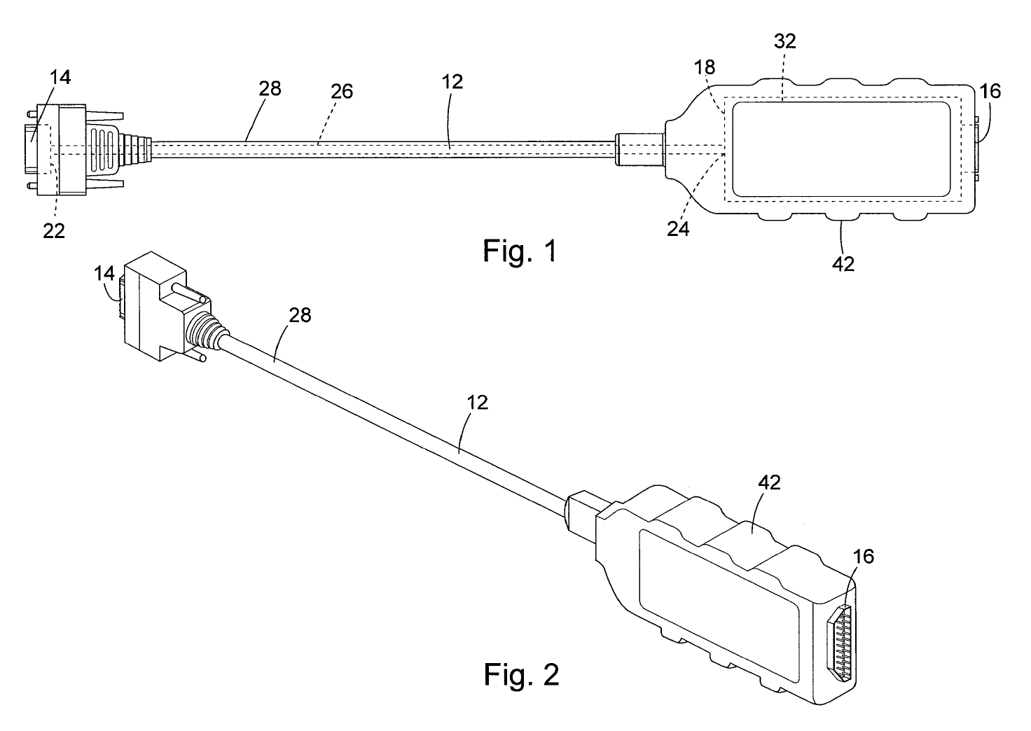

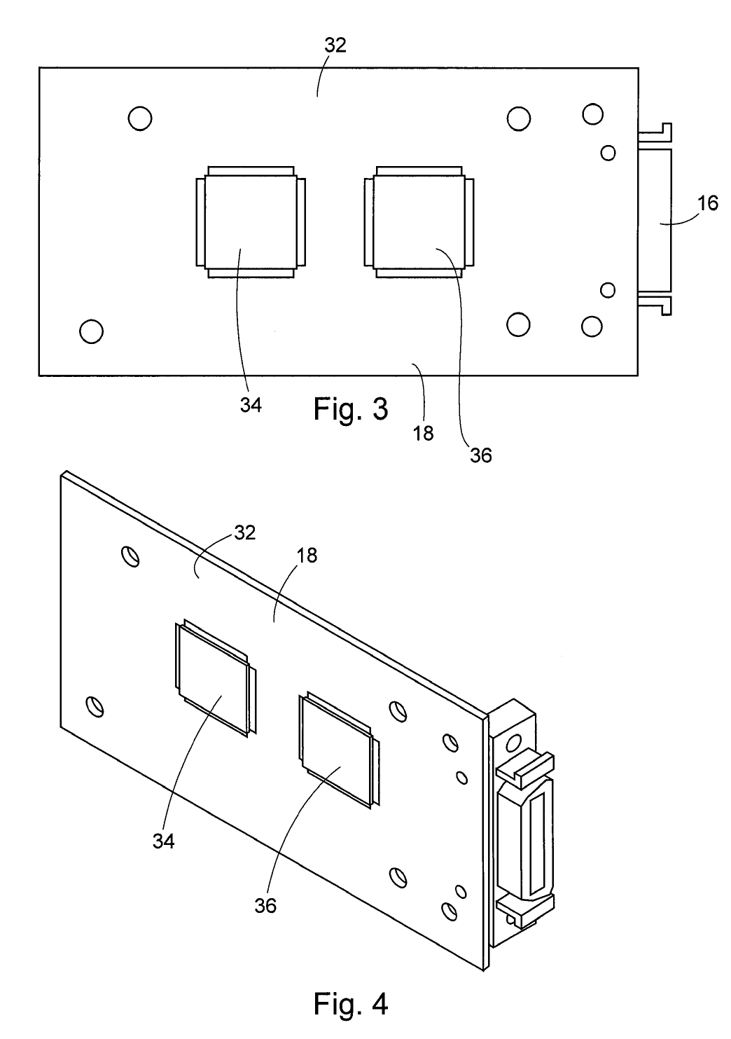

As stated earlier, the camera link booster cable assembly of the invention enables digital signals to be transmitted between a camera and a frame grabber over significantly larger distances than that provided by prior art cables. FIG. 1 shows a side view of the cable assembly of the invention. The cable assembly is basically comprised of a flexible cable 12, a first connector 14, a second connector 16, and a signal conditioning device 18.

The cable 12 has a flexible, elongate length with opposite first 22 and second 24 ends. An electrical conductor 26 extends through the cable from the first end 22 to the second end 24. The electrical conductor 26 can be a single length of copper wire that extends the length of the cable 12. In alternate embodiments the conductor 26 could be a plurality of braided wires that extend the length of the cable 12, or other equivalent means of conducting electrical signals could be used for the conductor 26. An electrically insulating shielding 28 surrounds the conductor 26. The shielding 28 extends the entire length of the cable 12 from the first end 22 to the second end 24.

The first connector 14 is electrically connected to the electrical conductor 26. The first connector 14 is adapted to be removably attached to an electrical connection of a camera to electrically communicate an electrical system of the camera with the electrical conductor 26. In the illustrated embodiment of the cable assembly, the first connector 14 is a delta ribbon connector. In alternate embodiments, the first connector 14 could be a miniature delta ribbon connector, or a high density delta ribbon connector, or an other equivalent connector.

The second connector 16 is also electrically connected with the electrical conductor 26. The second connector 16 is adapted to be removably attached to an electrical connection of a frame grabber to electrically communicate the electrical system of the frame grabber with the electrical conductor 26. In the illustrated embodiment, the second connector 16 is a delta ribbon connector. As with the first connector 14, the second connector 16 could also be a miniature delta ribbon connector, a high density delta ribbon connector, or some other equivalent connector.

The signal conditioning device 18 is electrically connected with the electrical conductor 26. In the illustrated embodiment of the cable assembly shown in the drawing figures, the signal conditioning device 18 is electrically connected to the first end of the electrical conductor 26 and is electrically connected to the first connector 14. A signal transmitted to the first connector by a camera electrically connected to the first connector will travel through the signal conditioning device 18 before traveling through the length of the conductor 26 and reaching the second connector 16. In alternate embodiments of the cable assembly, the signal conditioning device could be positioned at some other position along the length of the electrical conductor 26. The signal conditioning device 18 includes a printed circuit (pc) board 32 that is electrically connected between the first connector 14 and the electrical conductor 26. A receive chip 34 is mounted on the pc board 32 and is electrically connected to the first connector 26. The receive chip 34 is operational to receive signals transmitted from the first connector 14 and to decode the received signals. An example of a receive chip 34 is the National Semiconductor model ds90cr483. Other equivalent chips may be used in the signal conditioning device 18. A transmit chip 36 is also mounted on the pc board 32. The transmit chip 36 is connected in electrical communication with the receive chip 34 and with the first connector 14 by the pc board 32. The transmit chip 36 is operational to receive decoded signals from the receive chip 34 and to transmit signals through the conductor 26 to the second connector 16. An example of a transmit chip is the National Semiconductor model ds90cr484. Other equivalent types of chips may be used. The signal conditioning device 18 is fully enclosed in a housing 42. The housing 42 is constructed of an electrically insulating material. One end of the housing 42 surrounds the first connector 14, and the first connector 14 protrudes from this end of the housing 42. The opposite end of the housing 42 surrounds and is secured to the shielding 28 of the cable 12. The housing 42 thereby makes the signal conditioning device 18 an integral part of the cable assembly.

As shown in the drawing figures, a majority of the length of the cable 12 extends between the signal conditioning device 18 and the second connector 16. This elongate length of the cable 12 and the flexibility of the cable enabled by the presence of the signal conditioning device 18 allows a camera attached to the cable 12 at the first connector 14 to be freely manually manipulated relative to a frame grabber attached to the cable 12 at the second connector 16.

The cable assembly of the invention described above with the built-in signal conditioning device allows a signal from a camera to be transmitted to a frame grabber at a substantial distance from the camera. The signal from the camera is conditioned by the conditioning device to extend the distance that the signal can be transmitted down the conductor from approximately 7 meters at 85 MHz, to approximately 40 meters at 85 MHz. In alternate embodiments of the cable assembly, the conditioning device can be altered so that the speed of the transmitted signal from the camera to the frame grabber is increased to over 100 MHz. The cable assembly of the invention could also be used with less expensive cable to run high speed video signal transmissions at shorter lengths, or to allow a cable to transmit a video signal at higher speed, up to 112 MHz. The cable assembly also allows the use of smaller diameter, more flexible cable such as LVDS (low voltage differential SCSI) cable.

Although the cable assembly of the invention has been described above by reference to a particular embodiment of the cable assembly, it should be understood that modifications and variations could be made to the cable assembly without departing from the intended scope of the following claims.

What is claimed is:

1. A cable assembly that provides a communication connection between a camera and a separate frame grabber, the cable assembly comprising:
a flexible cable having an elongate length with opposite first and second ends, an electrical conductor extending through the cable from the first end to the second end, and an electrically insulating shielding surrounding the electrical conductor and extending along the cable from the first end to the second end;
a first connector at the cable first end, the first connector being electrically connected to the electrical conductor and being adapted for electrical connection to an electrical system of a camera to electrically communicate the camera electrical system with the cable electrical conductor;
a second connector at the cable second end, the second connector being electrically connected to the electrical conductor and being adapted for electrical connection to an electrical system of a frame grabber to electrically communicate the electrical system of the frame grabber with the cable electrical conductor; and,
a signal conditioning circuit in electrical communication with the cable electrical conductor.

2. The cable assembly of claim 1, further comprising:
the signal conditioning circuit is on a pc board, and the pc board is electrically connected to the electrical conductor between the first connector and the second connector.

3. The cable assembly of claim 2, further comprising:
a housing fully enclosing the pc board, the housing being constructed of an electrically insulating material and being secured to the cable electrically insulating shielding.

4. The cable assembly of claim 3, further comprising:
the housing being secured to the first connector.

5. The cable assembly of claim 3, further comprising:
a majority of the cable length extending between the housing and the second connector.

6. The cable assembly of claim 2, further comprising:
a receive chip on the pc board, the receive chip being operable to receive electric signals from the first connector and to decode the signals received from the first connector; and,
a transmit chip on the pc board, the transmit chip electrically communicating with the receive chip and being operable to receive decoded signals from the receive chip and to condition and transmit signals to the second connector.

7. The cable assembly of claim 6, further comprising:
the first and second connectors being delta ribbon connectors.

8. A cable assembly that provides a communication connection between a camera and a separate frame grabber, the cable assembly comprising:
a flexible cable having an elongate length with opposite first and second ends, an electrical conductor extending through the cable from the first end to the second end, and an electrically insulating shielding surrounding the electrical conductor and extending along the cable length from the first end to the second end;
a first connector at the cable first end, the first connector being electrically connected to the electrical conductor and being removably electrically connectable to an electrical system of a separate camera;
a single conditioning circuit at the cable first end, the signal conditioning circuit being electrically connected to the first connector; and,
a second connector at the cable second end, the second connector being electrically connected to the electrical conductor and being removably electrically connectable to an electrical system of a separate frame grabber.

9. The cable assembly of claim 8, further comprising:
the cable length extending between the signal conditioning circuit and the second connector.

10. The cable assembly of claim 9, further comprising:
a housing fully enclosing the signal conditioning circuit and surrounding the first connector with the first connector protruding from the housing, the housing being constructed of an electrically insulating material and being secured to the cable shielding.

11. The cable assembly of claim 10, further comprising:
the signal conditioning circuit is on a pc board, and the pc board is electrically connected to the electrical conductor between the first connector and the second connector.

12. The cable assembly of claim 11, further comprising:
a receive chip on the pc board, the receive chip being operable to receive electric signals from the first connector and to decode the signals received from the first connector; and,
a transmit chip on the pc board, the transmit chip electrically communicating with the receive chip and being operable to receive decoded signals from the receive chip and to condition and transmit signals to the second connector.

13. The cable assembly of claim 12, further comprising:
the first and second connectors being delta ribbon connectors.

14. A cable assembly that provides a communication connection between a camera and a separate frame grabber, the cable assembly comprising:
a flexible cable having an elongate length with opposite first and second ends, an electrical conductor extending through the cable from the first end to the second end, and an electrically insulating shielding surrounding the electrical conductor and extending along the cable from the first end to the second end of the cable;
a first delta ribbon connector at the cable first end, the first delta ribbon connector being electrically connected with the cable electrical conductor and being removably connectable to a separate camera;
a signal conditioning circuit at the cable first end, the signal conditioning circuit comprising a receive chip in electrical communication with the first delta ribbon connector, the receive chip being operable to receive signals from the first delta ribbon connector and to decode received signals, and the signal conditioning circuit comprising a transmit chip in electrical communication with the receive chip, the transmit chip being operable to receive decoded signals from the receive chip and to transmit signals; and,
a second delta ribbon connector at the cable second end, the second delta ribbon connector being electrically connected with the cable electrical conductor and being removably connectable to a separate frame grabber.

15. The cable assembly of claim 14, further comprising:
a housing fully enclosing the signal conditioning circuit and surrounding the first delta ribbon connector with the first delta ribbon connector protruding from the housing, the housing being constructed of an electrically insulating material and being secured around the cable shielding.

16. The cable assembly of claim 15, further comprising:
the cable length extending between the housing and the second delta ribbon connector.
